(19) United States
(12) Patent Application Publication
(10) Pub. No.: US 2023/0107172 A1
(43) Pub. Date: Apr. 6, 2023

(54) ONE-PIECE PRESSURE PLATE COLLECTOR

(71) Applicant: LOCKHEED MARTIN ENERGY, LLC, Bethesda, MD (US)

(72) Inventors: Steven John DaSilva, Sommerville, MA (US); Curtis S. Warrington, Acton, MA (US); Andrew Joseph Melough, Auburndale, MA (US)

(21) Appl. No.: 17/492,171

(22) Filed: Oct. 1, 2021

(51) Int. Cl. H01M 50/264; H01M 50/224

(52) U.S. Cl. CPC H01M 50/264; H01M 50/224

(57) ABSTRACT

Provided are one-piece end plates, which end plates can act as current collectors and are useful in electrochemical cell stack assemblies. The end plates can be secured to one another by floating tie rods that exert a pressure on the electrochemical cells disposed between the end plates.

### TECHNICAL FIELD

The present disclosure relates to the field of flow batteries and to the flow of electrochemical cell stacks.

### BACKGROUND

Existing electrochemical cell stacks typically include repeating units (e.g., electrodes and flow plates), but also include end assemblies (or non-repeats) that secure the stack together. Such end plates can be secured to one another via tie rods, with the tie rods acting to compress the stack of components together.

This approach typically includes multiple parts, including—separately—a pressure plate, an insulation sheet, a current collector, and an electrode. Such a multicomponent design, however, suffers from a number of shortcomings.

First, the current collector is formed of sheet metal, which approach faces challenges in achieving the necessary flatness tolerance. The current collector is also normally gold-plated, which poses cost challenges. Further, the existing approach can result in poor electrical isolation from current collector to the tie rods, which can reduce the performance of the overall assembly.

Accordingly, there is a long-felt need in the art for improved end assemblies for electrochemical cell stack assemblies.

### SUMMARY

In meeting the described long-felt needs, the present disclosure provides, inter alia, an electrochemical stack assembly, comprising: a first end plate, the first end plate having a thickness, the first end plate being formed of a conductive metallic material, the first end plate having a plurality of tie rod through holes formed through the thickness of the first end plate; a plurality of electrically insulating sleeves, each of the electrically insulating sleeves being configured (1) for insertion through a tie rod through hole and (2) for acceptance of a tie rod inserted therethrough; and a plurality of tie rods, the plurality of tie rods configured for insertion through the electrically insulating sleeves and to secure the first end plate to a second end plate located at a distance from the first end plate, as measured in a direction along one of the plurality of tie rods, and a plurality of one or more electrochemical cells disposed between the first end plate and the second end plate, the first end plate being configured to collect a current from one or more of the plurality of electrochemical cells.

Also provided is an electrochemical stack end plate, comprising: a conductive metallic material plate having a thickness, the plate having a plurality of tie rod through holes formed through the thickness of the first end plate; a plurality of electrically insulating sleeves, each of the electrically insulating sleeves being configured (1) for insertion through a tie rod through hole and (2) for acceptance of a tie rod inserted therethrough; and the conductive metallic material plate comprising an electrical connection feature configured to place the plate into electronic communication with the environment exterior to the plate.

Additionally disclosed is a method, comprising: securing with one or more tie rods, a conductive first end plate, a second end plate, and a plurality of electrochemical cells disposed between the first end plate and the second end plate, the securing being performed so as to physically secure the plurality of electrochemical cells in position between the first end plate and the second end plate, the one or more tie rods being in electrical isolation from the conductive first end plate, and the conductive first end plate being configured to collect a current from the plurality of electrochemical cells.

Further provided is a method, comprising operating an electrochemical stack assembly according to the present disclosure so as to store or release electrical energy.

Also disclosed is a method, comprising: through a first conductive end plate secured to a second end plate, communicating a first active material to one or more electrochemical cells disposed between the first conductive end plate and the second end plate such that the first active material can interact with a second active material, the first active material and the second active material being separated by an ion exchange membrane, the electrochemical cells secured in position by way of a pressure exerted between the first conductive end plate and the second end plate; and (a) from the first conductive end plate, collecting a current related to interaction between the first active material and the second active material across the ion exchange membrane, or (b) communicating a current into the first conductive end plate so as to increase an energy density of one or both of the first active material and the second active material.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 provides an exploded view of (left panel) an exemplary assembly that includes a pressure plate and a current collector and (right panel) an exemplary assembly according to the present disclosure.

FIG. 2 provides an exploded view of an electrochemical stack assembly according to the present disclosure; and

FIG. 3 provides an exploded view of an electrochemical stack assembly according to the present disclosure.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints, 2 grams and 10 grams, and all the intermediate values. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

Figures

The appended figures are illustrative only and do not serve to limit the scope of the present disclosure or the attached claims.

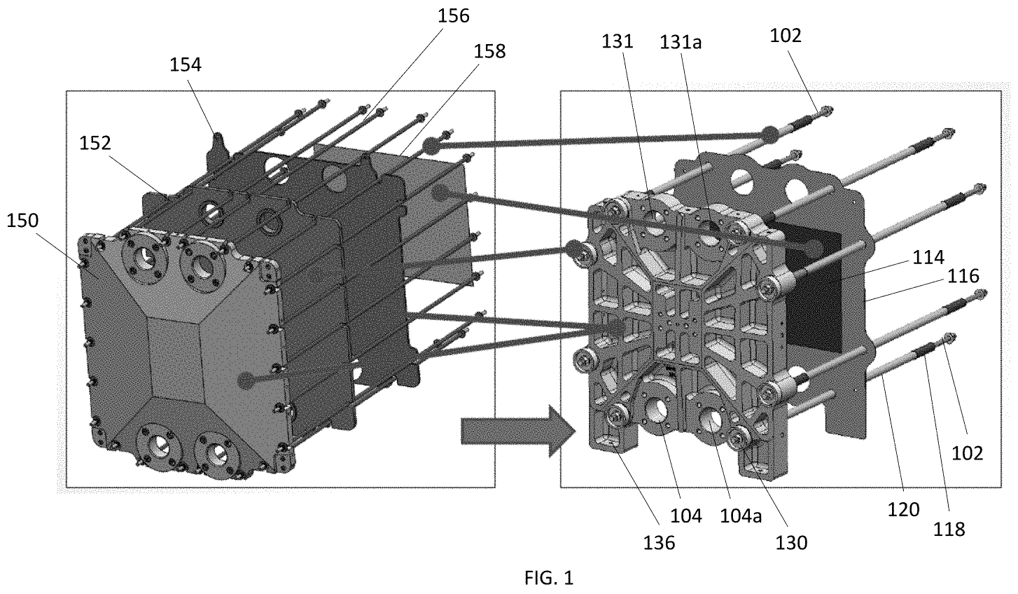

FIG. 1 provides an exploded view of (left panel) of a generalized exemplary assembly that includes a pressure plate and a current collector and (right panel) an exemplary assembly according to the present disclosure.

As shown in FIG. 1, an assembly can include a pressure plate 150, an insulator plate 152, a current collector 154, and a cushion electrode 158. Tie rods 156 can be used to maintain these various components in position. As shown, the tie rods can extend through holes formed in pressure plate 150. Current collector 154 can include a tab or other extended or cantilevered feature (upper left of current collector 154) to which feature an electrical load or other element can be connected.

The right panel of FIG. 1 provides an exploded view of an assembly according to the present disclosure. As shown, an assembly can include a pressure plate collector 136. This element can be formed of a conductive material, e.g., copper, iron, or other conductive metal.

Pressure plate collector 136 can include one or more apertures (shown by 104, 104a, 131, and 131a) formed therein. An aperture can be configured to accept (e.g., as an inlet) an active material (e.g., electrolyte) introduced from exterior to the pressure plate collector; an aperture can also be configured to accept a fluid communication train that is configured to introduce an active material to the other components (e.g., electrochemical cells) of the stack. An aperture can be configured to act as an inlet and/or as an outlet. For example, a pair of apertures can be configured to act as an inlet and an outlet for a first active material (e.g., a posolyte) that is introduced to and withdrawn from the stack assembly and also as an inlet and an outlet for a second active material (e.g., a negolyte) that is introduced and withdrawn from the stack assembly.

As shown, pressure collector plate 136 can include one or more features (not labeled) milled therein. Without being bound to any particular theory or embodiment, pressure plate collector 136 can serve the function of pressure plate 150 and current collector 154 shown in the generalized embodiment at the left panel of FIG. 1.

Also as shown in FIG. 1 (right panel), pressure plate collector 136 can include one or more tie rod through holes (not labeled) formed therein, each of which tie rod through holes can accept a tie rod (102) inserted therethrough.

The assembly can also include one or more electrically insulating sleeves 130. Such a sleeve can be configured to fit within a tie rod through hole and then the tie rod can be inserted through/in the sleeve. In this way, the tie rod is maintained in electrical isolation (by the electrically insulating sleeve) from pressure plate collector 136.

An electrically insulating sleeve can be formed of a rigid material, although this is not a requirement, as the sleeve can be formed from a flexible material as well. An electrically insulating sleeve can have a length that is greater than the thickness of pressure plate collector 136 such that one or both ends of the electrically insulating sleeve extend or protrude beyond pressure plate collector 136. This is not a requirement, however, and the length of insulating sleeve 130 can also be less than the thickness of pressure plate collector 136 such that one or both ends of insulating sleeve 130 are located within the thickness of pressure plate collector 136.

An assembly can also include (not shown) a housing or other mechanism configured to maintain tie rod 102 in physical isolation (e.g., via floating) from insulating sleeve 130 and/or pressure plate collector 130. Insulating sleeve 130 can operate similarly to insulator plate 152 shown in the left-hand panel of FIG. 1. Insulator plate 152 insulates pressure plate 150 (which can be a dead metal part) from current collector 154. The tie-rods 156 can also be dead metal, as they are connected to pressure plate 150. By “dead metal” is meant not electrically live. Such dead metal may or may not be grounded. Insulating sleeve 130 insulates 102 (tie rods, dead metal) from pressure plate collector 136. In both designs the insulation components insulate the electrically live components from the dead metal parts

A tie rod 102 can be formed of a metal material, although this is not a requirement. Electrical insulation 120 (which can be present as a sleeve) can be disposed on tie rod 102; such a sleeve can be secured to the tie rod via adhesive or by other sleeves or rings, e.g., via sealing sleeve 118, which can be formed of a heat-shrinkable material. As shown, tie rod 102 of the embodiment shown in the right-hand panel can operate similarly to tie rod 158 of the embodiment shown in the left-hand panel.

Also shown in the right-hand panel of FIG. 1 is electrode 114, which operates similarly to cushion electrode 158 in the embodiment shown in the left panel of FIG. 1. As shown, cushion electrode 114 can be, e.g., a portion of conductive fabric mounted within a frame. The portion of conductive fabric can physically contact pressure plate collector 136; the cushion electrode can also act to place an active material (e.g., a material that wets the conductive fabric of the cushion electrode) into physical or electrical contact with pressure plate collector 136.

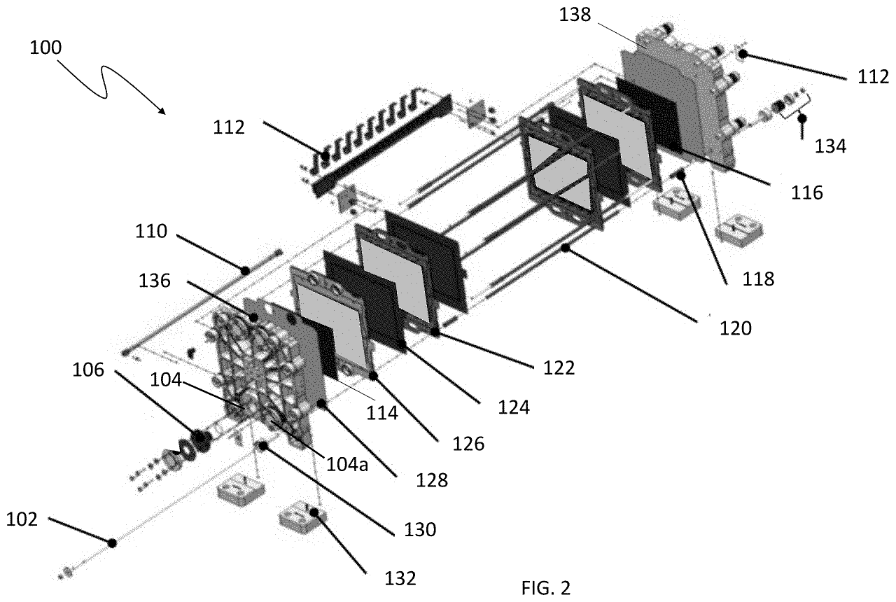

FIG. 2 provides an exploded view of an electrochemical stack assembly 100 according to the present disclosure. As shown in FIG. 2, an assembly can include pressure plate collector 136, which pressure plate collector can include features (not shown) milled therein, e.g., slots, ridges, or other engagement features.

A fluid communication train can be placed into fluid communication with one or more apertures (not labeled) of pressure plate collector 136. Such a train can include, e.g., fluid manifold inserts (106) (e.g., piping, valves, and the like) that can be used to facilitate the introduction (and/or withdrawal) of active materials, such as posolytes and negolytes. A fluid manifold can include caps, gaskets, and other components.

An insulating sleeve (which can also be termed a pressure plate isolator) 130 can be inserted through a tie rod through hole of pressure plate collector 136. As described elsewhere herein, an insulated sleeve can have a length that is greater than the thickness of pressure plate collector 136, although this is not a requirement.

One or more tie rods 102 can be used to secure pressure plate collector 136 to another pressure plate 138, which other pressure plate can also be a conductive material. The tie rods 102 serve the secure pressure plates 136 and 138 to one another, while also securing various other components (e.g., electrochemical cells) that are disposed between the two pressure plates in a stacked-type configuration. As shown, assembly 100 can include electrode 116, which electrode 116 can be constructed similar to or even identical to electrode 114 (described elsewhere herein).

As shown, electrical insulation 120 can be disposed on a tie rod. Such insulation can be, e.g., a sleeve or other form of insulating material. The electrical insulation can be secured to the tie rod via one or more sealing sleeves 118; such sleeves can be, e.g., heat-shrinkable materials, and can themselves be insulating materials.

For example, corrosion barrier 128 (which can be conductive, but can also be insulating) can be disposed between pressure plate collector 136 and electrode 114. Electrode 114 can comprise a conductive fabric, which fabric can be secured by or within a frame.

As shown, stack 100 can also include a monopolar plate assembly 126, which monopolar plate assembly can include a flow plate comprising channels, manifolds, or other features configured to communicate and distribute an active material, e.g., a posolyte or a negolyte to an electrode.

As shown, assembly 100 can include a so-called soft goods assembly 124, which can include one or more electrodes and an ion exchange membrane. As an example, a soft goods assembly can include an ion exchange membrane disposed between a first electrode and a second electrode, which first and second electrodes are configured to be wetted by active materials, with ion exchange then proceeding across the ion exchange membrane, between the active materials.

A bipolar plate assembly 122 can be disposed within assembly 100, as shown. The bipolar plate assembly can include, inter alia, a bipolar plate that includes channels, manifolds, or other features configured to communicate and distribute one or more active materials, e.g., posolyte, negolyte, to an electrode. Further electrodes, ion exchange membranes, and mono- and bi-polar plates can be assembled within assembly 100.

As shown in FIG. 2, assembly 100 can include isolator feet 132, which isolator feet can act to physically and/or electrically isolate assembly 100 from the surface on which the assembly rests.

Also as shown in FIG. 2, assembly 100 can include an element 134 (e.g., a disc spring assembly) configured to place a tie rod into physical and/or electrical isolation from the pressure plates and other components of the assembly. This isolation can be accomplished by placing the rod into a floating configuration; “floating” refers to the fact that the tie-rod is a dead metal part that is not connected to any another metal part that then may or may not be connected to ground. Thus, it is “floating” electrically without connection to anything. An assembly can include an identifier 112 (e.g., a tag, label, stamp, or other index).

An assembly according to the present disclosure can also include a shorting strap 110. The shorting strap can be used to, e.g., discharge the assembly before a maintenance procedure. Assembly 100 can also include one or more monitors (112). A monitor can be configured to, e.g., monitor an electrical condition (e.g., voltage, current, and the like) of one or more components of assembly 100.

As an example, an assembly can include one or more monitors configured to measure a voltage at one or more electrochemical cells within the assembly. In this way, monitor(s) 112 can act as a health monitor for the stack, allowing the user to determine if one or more cells of a stack are not operating according to the user's needs or design.

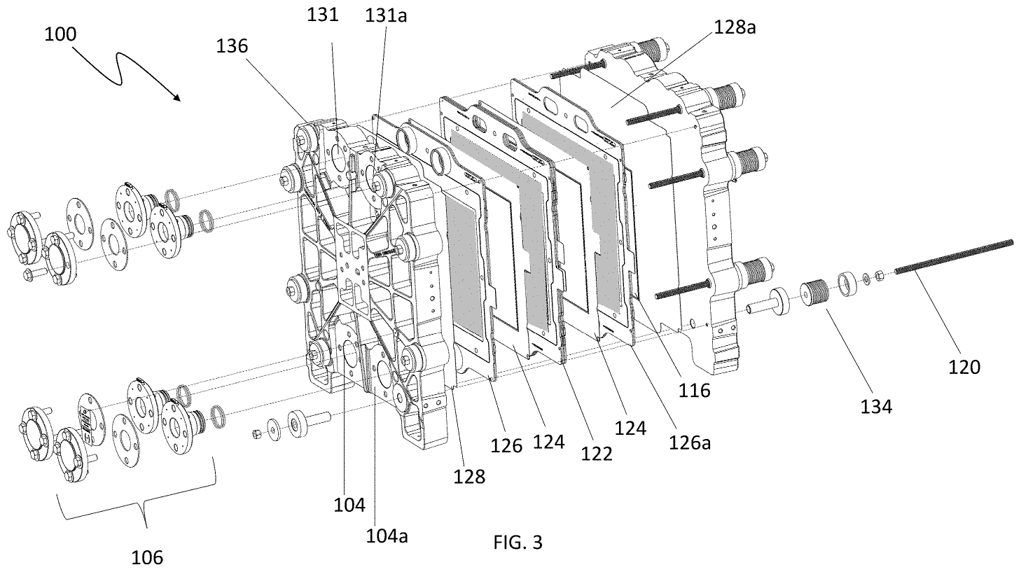

A closer view of an exemplary assembly is provided in FIG. 3. As shown, an assembly can include pressure plate collector 136. Pressure plate collector 136 can include one or more apertures (shown by 104, 104a, 131, and 131a) formed therein.

An aperture can be configured to accept (e.g., as an inlet) an active material (e.g., electrolyte) introduced from exterior to the pressure plate collector; an aperture can also be configured to accept a fluid communication train that is configured to introduce an active material to the other components (e.g., electrochemical cells) of the stack.

An aperture can be configured to act as an inlet and/or as an outlet. For example, a pair of apertures can be configured to act as an inlet and an outlet for a first active material (e.g., a posolyte) that is introduced to and withdrawn from the stack assembly and also as an inlet and an outlet for a second active material (e.g., a negolyte) that is introduced and withdrawn from the stack assembly. As shown, one or more fluid manifold inserts 106 can be used to facilitate the introduction (and/or withdrawal) of active materials, such as posolytes and negolytes.

As shown, corrosion barrier 128 can be disposed between pressure plate collector 136 and an electrode (not shown). The electrode can be in electronic communication with monopolar plate 126.

The monopolar plate 126 can in turn be in electrical communication (or even physical contact) with so-called soft goods assembly 124, which can include one or more electrodes and an ion exchange membrane.

As an example, a soft goods assembly can include an ion exchange membrane disposed between a first electrode and a second electrode, which first and second electrodes are configured to be wetted by active materials, with ion exchange then proceeding across the ion exchange membrane, between the active materials.

A bipolar plate 122 can be disposed between soft good assemblies 124, as shown in FIG. 3. A further monopolar plate 126a can be positioned next to soft good assembly 124, as shown. Electrode 116 can be positioned as shown, next to monopolar plate 126a. A corrosion barrier 128a can also be present, as shown.

Also as shown in FIG. 3, a tie rod (not labeled) can be used to secure an assembly together. The tie rod can be enclosed within electrical insulation 120. Such insulation can be, e.g., a sleeve or other form of insulating material. The electrical insulation can be secured to the tie rod via one or more sealing sleeves; such sleeves can be, e.g., heat-shrinkable materials, and can themselves be insulating materials.

Also as shown in FIG. 3, assembly 100 can include an element 134 (e.g., a disc spring assembly) configured to place a tie rod into physical and/or electrical isolation from the pressure plates and other components of the assembly. This isolation can be accomplished by placing the rod into a floating configuration.

### EMBODIMENTS

The following Embodiments are illustrative only and do not limit the scope of the present disclosure or the appended claims.

Embodiment 1. An electrochemical stack assembly, comprising: a first end plate, the first end plate having a thickness, the first end plate being formed of a conductive metallic material, the first end plate having a plurality of tie rod through holes formed through the thickness of the first end plate; a plurality of electrically insulating sleeves, each of the electrically insulating sleeves being configured (1) for insertion through a tie rod through hole and (2) for acceptance of a tie rod inserted therethrough; and a plurality of tie rods, the plurality of tie rods configured for insertion through the electrically insulating sleeves and to secure the first end plate to a second end plate located at a distance from the first end plate, as measured in a direction along one of the plurality of tie rods, and a plurality of one or more electrochemical cells disposed between the first end plate and the second end plate, the first end plate being configured to collect a current from one or more of the plurality of electrochemical cells.

Embodiment 2. The electrochemical stack assembly of Embodiment 1, further comprising a plurality of tie rod float assemblies, each tie rod assembly being configured to engage with a given tie rod and one or both of (i) an electrically insulating sleeve and (ii) a tie rod through hole so as to maintain that tie rod in a floating position relative to a tie rod through hole associated with that tie rod.

Embodiment 3. The electrochemical stack assembly of Embodiment 2, wherein a tie rod float assembly comprises a resilient member. A resilient member can be, e.g., one or more of an elastomer and a spring.

Embodiment 4. The electrochemical stack assembly of any one of Embodiments 1 to 3, wherein each tie rod comprises electrical insulation disposed thereon. The electrical insulation can be present as a sleeve, as multiple sleeves or bands, and the like. The insulation can be adhered to the tie rod.

Embodiment 5. The electrochemical stack assembly of Embodiment 4, wherein the electrical insulation comprises an insulating sleeve engaged with the tie rod by one or more sealing sleeves. As an example, one can use sealing sleeves at either end of the insulating sleeve to secure the insulating sleeve in place.

Embodiment 6. The electrochemical stack assembly of any one of Embodiments 1 to 5, further comprising a compressible electrode contacting with the first end plate, the electrochemical stack assembly optionally comprising a corrosion barrier disposed between the electrode and the first end plate.

The compressible electrode can include, e.g., a conductive fabric. Such a fabric can be woven, but this is not a requirement, as the fabric can also be a non-woven fabric. The compressible electrode can comprise a carbonaceous material, e.g., carbon fiber. The electrode can also include metallic conductors, e.g., wires.

Embodiment 7. The electrochemical stack assembly of Embodiment 8, wherein the compressible electrode is disposed within a frame configured to permit a maximum degree of compression of the compressible electrode.

The frame can be configured such that the frame prevents components (e.g., a monopolar plate, a bipolar plate) positioned next to the electrode from compressing the electrode beyond a certain degree of compression, e.g., such that the electrode (or a portion of the electrode) does not go below a certain minimum thickness.

Embodiment 8. The electrochemical stack assembly of any one of Embodiments 1 to 7, wherein the plurality of electrochemical cells comprises at least two electrochemical cells of essentially identical dimensions.

Embodiment 9. The electrochemical stack assembly of any one of Embodiments 1 to 8, wherein the first end plate comprises an active material inlet formed therethrough and an active material outlet formed therethrough. An end plate can include one inlet, but can also include a plurality of inlets. Likewise, an end plate can include one outlet, but can also include a plurality of outlets.

Embodiment 10. The electrochemical stack assembly of Embodiment 9, further comprising a fluid communication train configured to communicate an active material from a location exterior to the first end plate (1) through the active material inlet of the first end plate, (2) to one or more of the electrochemical cells disposed between the first end plate and the second end plate, and (3) through the active material outlet of the first end plate.

A fluid communication train can include, e.g., a manifold, a valve, and the like. A fluid communication train can be configured to communicate the active material to one, two, three, or more electrochemical cells disposed between the first end plate and the second end plate.

An assembly can be configured such that a first fluid communication train communicates an active material to a first electrochemical cell or a first set of electrochemical cells and a second fluid communication train communicates an active material to a second electrochemical cell or a second set of electrochemical cells. An assembly can include one or more fluid communication trains, e.g., such that the assembly can operate while one of the trains is offline or otherwise undergoing maintenance.

Multiple trains can also be used so as to allow the assembly to operate continuously, e.g., so as to allow the assembly to switch over from one supply of active material to another supply when the first supply becomes exhausted or is being replaced.

Embodiment 11. The electrochemical stack assembly of any one of Embodiments 1 to 10, wherein the first end plate comprises one or more features milled therein. Exemplary features include, e.g., slots, tabs, and the like. An end plate can include features that engage with complementary features of, e.g., other end plates, housings, floors, shipping containers, and the like.

Embodiment 12. The electrochemical stack assembly of any one of Embodiments 1 to 11, wherein the second end plate comprises a plurality of tie rod through holes in register with the plurality of tie rod through holes of the first end plate.

Embodiment 13. An electrochemical stack end plate, comprising: a conductive metallic material plate having a thickness, the plate having a plurality of tie rod through holes formed through the thickness of the first end plate; a plurality of electrically insulating sleeves, each of the electrically insulating sleeves being configured (1) for insertion through a tie rod through hole and (2) for acceptance of a tie rod inserted therethrough; and the conductive metallic material plate comprising an electrical connection feature configured to place the plate into electronic communication with the environment exterior to the plate.

Embodiment 14. The electrochemical stack end plate of Embodiment 13, further comprising a plurality of tie rod float assemblies, each tie rod assembly being configured to engage with a given tie rod and one or both of (i) an electrically insulating sleeve and (ii) a tie rod through hole so as to maintain that tie rod in a floating position relative to a tie rod through hole associated with that tie rod.

Embodiment 15. The electrochemical stack end plate of Embodiment 14, wherein a tie rod float assembly comprises a resilient member. Suitable resilient members are described elsewhere herein.

Embodiment 16. The electrochemical stack end plate of any one of Embodiments 13 to 15, further comprising an active material inlet formed therethrough and an active material outlet formed therethrough. Exemplary inlet and outlet configurations are provided elsewhere herein.

Embodiment 17. The electrochemical stack end plate of Embodiment 16, further comprising a feature formed therein configured to allow attachment of a fluid communication train to the active material inlet in a specific orientation.

Embodiment 18. A method, comprising: securing with one or more tie rods, a conductive first end plate, a second end plate, and a plurality of electrochemical cells disposed between the first end plate and the second end plate, the securing being performed so as to physically secure the plurality of electrochemical cells in position between the first end plate and the second end plate, the one or more tie rods being in electrical isolation from the conductive first end plate, and the conductive first end plate being configured to collect a current from the plurality of electrochemical cells.

Embodiment 19. The method of Embodiment 18, wherein the tie rods are disposed within insulating sleeves engaged with the conductive first end plate.

Embodiment 20. The method of any one of Embodiments 18 to 19, wherein each tie rod is in a floating position relative to a tie rod through hole of the conductive first end place that is associated with that tie rod. A tie rod can be maintained in its floating position by, e.g., one or more resilient members, such as a spring or an elastomer.

Embodiment 21. A method, comprising operating an electrochemical stack assembly according to any one of Embodiments 1 to 12 so as to store or release electrical energy. Without being bound to any particular theory or approach, one can introduce a current to the active material in the electrochemical stack assembly so as to charge the active material for use at a later time. Similarly, one can circulate active material (e.g., posolyte and negolyte) within an assembly so as to evolve an electric current and then collect the evolved current.

Embodiment 22. A method, comprising: through a first conductive end plate secured to a second end plate, communicating a first active material to one or more electrochemical cells disposed between the first conductive end plate and the second end plate such that the first active material can interact with a second active material, the first active material and the second active material being separated by an ion exchange membrane, the electrochemical cells secured in position by way of a pressure exerted between the first conductive end plate and the second end plate; and (a) from the first conductive end plate, collecting a current related to interaction between the first active material and the second active material across the ion exchange membrane, or (b) communicating a current into the first conductive end plate so as to increase an energy density of one or both of the first active material and the second active material.

Embodiment 23. The method of Embodiment 22, comprising from the first conductive end plate, collecting a current related to interaction between the first active material and the second active material across the ion exchange membrane.

Embodiment 24. The method of Embodiment 22, comprising communicating a current into the first conductive end plate so as to increase an energy density of one or both of the first active material and the second active material.

Embodiment 25. The method of any one of Embodiments 22 to 24, further comprising withdrawing the first active material through the first conductive end plate.

Embodiment 26. The method of any one of Embodiments 22 to 25, wherein the first active material is communicated through a fluid communication train extending through the first conductive end plate.

Embodiment 27. The method of any one of Embodiments 22 to 26, wherein the first conductive end plate and the second end plate are secured to one another by one or more tie rods, the one or more tie rods being in electrical isolation from the first conductive end plate.

Embodiment 28. The method of Embodiment 27, wherein the one or more tie rods are floating relative to the first conductive end plate and the second end plate.

Embodiment 29. The method of any one of Embodiments 22 to 28, wherein the one or more electrochemical cells comprises from 100 to 300 electrochemical cells. A user can use, e.g., 1 to 300 cells, 2 to 295 cells, 3 to 290 cells, 5 to 270 cells, 7 to 250 cells, 10 to 230 cells, 15 to 215 cells, 20 to 200 cells, 25 to 175 cells, 35 to 165 cells, 55 to 155 cells, 65 to 140 cells, 75 to 135 cells, 85 to 125 cells, 95 to 115 cells, or even 100 cells.

Embodiment 30. The method of any one of Embodiments 22 to 29, further comprising monitoring an electrical condition of at least one of the one or more electrochemical cells. Example conditions include, e.g. (and without limitation), cell voltage. If compared to all the other cell voltages and the full stack voltage, some assumptions can be made about the status of any particular cell or cell(s), especially if performance or other metrics are not being met.

What is claimed:

1. An electrochemical stack assembly, comprising:
a first end plate,
the first end plate having a thickness,
the first end plate being formed of a conductive metallic material,
the first end plate having a plurality of tie rod through holes formed through the thickness of the first end plate;
a plurality of electrically insulating sleeves,
each of the electrically insulating sleeves being configured (1) for insertion through a tie rod through hole and (2) for acceptance of a tie rod inserted therethrough; and
a plurality of tie rods,
the plurality of tie rods configured for insertion through the electrically insulating sleeves and to secure the first end plate to a second end plate located at a distance from the first end plate, as measured in a direction along one of the plurality of tie rods, and
a plurality of electrochemical cells disposed between the first end plate and the second end plate,
the first end plate being configured to collect a current from one or more of the plurality of electrochemical cells.

2. The electrochemical stack assembly of claim 1, further comprising a plurality of tie rod float assemblies, each tie rod assembly being configured to engage with a given tie rod and one or both of (i) an electrically insulating sleeve and (ii) a tie rod through hole so as to maintain that tie rod in a floating position relative to a tie rod through hole associated with that tie rod.

3. The electrochemical stack assembly of claim 2, wherein a tie rod float assembly comprises a resilient member.

4. The electrochemical stack assembly of claim 1, wherein each tie rod comprises electrical insulation disposed thereon.

5. The electrochemical stack assembly of claim 4, wherein the electrical insulation comprises an insulating sleeve engaged with the tie rod by one or more sealing sleeves.

6. The electrochemical stack assembly of claim 1, further comprising a compressible electrode contacting with the first end plate, the electrochemical stack assembly optionally comprising a corrosion barrier disposed between the electrode and the first end plate.

7. The electrochemical stack assembly of claim 8, wherein the compressible electrode is disposed within a frame configured to permit a maximum degree of compression of the compressible electrode.

8. The electrochemical stack assembly of claim 1, wherein the first end plate comprises an active material inlet formed therethrough and an active material outlet formed therethrough.

9. The electrochemical stack assembly of claim 8, further comprising a fluid communication train configured to communicate an active material from a location exterior to the first end plate (1) through the active material inlet of the first end plate, (2) to one or more of the electrochemical cells disposed between the first end plate and the second end plate, and (3) through the active material outlet of the first end plate.

10. The electrochemical stack assembly of claim 1, wherein the first end plate comprises one or more features milled therein.

11. The electrochemical stack assembly of claim 1, wherein the second end plate comprises a plurality of tie rod through holes in register with the plurality of tie rod through holes of the first end plate.

12. An electrochemical stack end plate, comprising:
a conductive metallic material plate having a thickness,
the plate having a plurality of tie rod through holes formed through the thickness of the first end plate;
a plurality of electrically insulating sleeves,
each of the electrically insulating sleeves being configured (1) for insertion through a tie rod through hole and (2) for acceptance of a tie rod inserted therethrough; and
the conductive metallic material plate comprising an electrical connection feature configured to place the plate into electronic communication with the environment exterior to the plate.

13. The electrochemical stack end plate of claim 12, further comprising a plurality of tie rod float assemblies, each tie rod assembly being configured to engage with a given tie rod and one or both of (i) an electrically insulating sleeve and (ii) a tie rod through hole so as to maintain that tie rod in a floating position relative to a tie rod through hole associated with that tie rod.

14. The electrochemical stack end plate of claim 13, wherein a tie rod float assembly comprises a resilient member.

15. The electrochemical stack end plate of claim 12, further comprising an active material inlet formed therethrough and an active material outlet formed therethrough.

16. The electrochemical stack end plate of claim 15, further comprising a feature formed therein configured to allow attachment of a fluid communication train to the active material inlet in a specific orientation.

17. A method, comprising:
securing with one or more tie rods, a conductive first end plate, a second end plate, and a plurality of electrochemical cells disposed between the first end plate and the second end plate,
the securing being performed so as to physically secure the plurality of electrochemical cells in position between the first end plate and the second end plate,
the one or more tie rods being in electrical isolation from the conductive first end plate, and
the conductive first end plate being configured to collect a current from the plurality of electrochemical cells.

18. The method of claim 17, wherein the tie rods are disposed within insulating sleeves engaged with the conductive first end plate.

19. The method of claim 18, wherein each tie rod is in a floating position relative to a tie rod through hole of the conductive first end place that is associated with that tie rod.

20. A method, comprising operating an electrochemical stack assembly according to claim 1 so as to store or release electrical energy.
